(19) United States
(12) Patent Application Publication
(10) Pub. No.: US 2026/0188863 A1
(43) Pub. Date: Jul. 2, 2026

(54) BATTERY ASSEMBLY, BATTERY AND ELECTRIC VEHICLE

(71) Applicant: Microvast, Inc., Stafford, TX (US)

(72) Inventors: Xiaojie SHEN, Huzhou (CN); Guoyou DENG, Huzhou (CN); Yong JIN, Huzhou (CN); Xiaofeng YIN, Huzhou (CN)

(73) Assignee: Microvast, Inc., Stafford, TX (US)

(21) Appl. No.: 18/868,146

(22) PCT Filed: Aug. 2, 2022
(86) PCT No.: PCT/CN2022/109808

§ 371 Date: Nov. 21, 2024

(30) Foreign Application Priority Data
May 24, 2022 (CN) 202210568102.8

(51) Int. Cl. H01M 50/533; H01M 50/107; H01M 50/148; H01M 50/166; H01M 50/186; H01M 50/528; H01M 50/536; H01M 50/538

(52) U.S. Cl. CPC H01M 50/533; H01M 50/107; H01M 50/154; H01M 50/166; H01M 50/186; H01M 50/528; H01M 50/536; H01M 50/538; H01M 2220/20

(57) ABSTRACT

The present application provides a battery assembly, including an electrode pole and a current collecting plate. The current collecting plate includes a plate body and an electrical connection portion; the electrical connection portion is formed by extending and protruding from the plate body towards the electrode pole; the electrode pole is provided with a central hole, the electrical connection portion is inserted into the central hole, the side wall of the electrical connection portion and the inner wall of the central hole are fixed by welding, and the electrical connection portion is electrically connected with the electrode pole. The present application further provides a battery and an electric vehicle.

### TECHNICAL FIELD

The present application relates to the technical field of batteries, and in particular, to a battery assembly, a battery and an electric vehicle.

### DESCRIPTION OF RELATED ART

With the development of electronic technology, lithium-ion batteries have been widely used because of its advantages such as high specific power, long cycle life, good safety performance, low pollution, etc. In order to improve the battery cell capacity and reduce the manufacturing cost of the battery, the diameter of the cylindrical battery also began to increase gradually.

### BRIEF SUMMARY OF THE APPLICATION

### Technical Problem

In order to meet the charge/discharge and heat dissipation requirements of the large-diameter and high-capacity cylindrical battery, the wounded cell of the cylindrical battery is designed with full tabs, and the positive and negative tabs of the wounded cell are connected to the positive and negative electrodes of the battery through positive and negative current collecting plates. Generally, the electrical connector of the positive current collecting plate is bent into a “Z” shape to connect the positive tabs of the wounded cell and the positive electrode of the battery. In this way, the electrical connector of the positive current collecting plate is prone to crack at the bending position, the current path from the positive electrode of the battery to the positive tabs of the wounded cell is long, the internal resistance of the positive current collecting plate is large, and the positive current collecting plate generates a large amount of heat during the charging and discharging process.

### Technical Solution

The object of the present application is to provide a battery assembly, a battery and an electric vehicle, so as to solve or at least partially solve the shortcomings of the above background technology. The electrical connection portion is directly connected with the plate body and the electrode pole, greatly reducing the internal resistance of the current collecting plate, thereby improving the electrical conductivity of the battery. Further, the electrical connector on the current collecting plate does not need to be bent in a “Z” shape, is not easy to crack, and has high assembly efficiency, which is suitable for industrial production.

An embodiment of the present application provides a battery assembly, which includes an electrode pole and a current collecting plate, wherein the current collecting plate includes a plate body and an electrical connection portion, the electrical connection portion is formed by extending and protruding from the plate body towards the electrode pole, the electrode pole is provided with a central hole, the electrical connection portion is inserted into the central hole, and a side wall of the electrical connection portion and an inner wall of the central hole are fixed by welding, the electrical connection portion is electrically connected with the electrode pole.

In one realizable way, the side wall of the electrical connection portion is in contact with the inner wall of the central hole to realize the electrical connection between the electrical connection portion and the electrode pole. Since the side wall of the electrical connection portion is in contact with the inner wall of the central hole, the electrical connection between the electrical connection portion and the electrode pole can be realized through the contact itself before welding, and the subsequent welding mainly plays a fixing role. It can also be that the side wall of the electrical connection portion does not contact the inner wall of the central hole before welding, for example, there is a small gap between them, and the electrical connection and fixation between the electrical connection portion and the electrode pole can be realized later by welding.

In one realizable way, the electrical connection portion is a truncated cone shaped structure, with a diameter gradually decreasing along the direction away from the plate body, the inner wall of the electrode pole is provided with a bevel matching the shape of the electrical connection portion, and the side wall of the electrical connection portion is in contact with the bevel.

In one realizable way, the inner wall of the electrode pole is provided with a lateral indenting structure near welding position, and a lateral indenting space for increasing the welding space is formed between the lateral indenting structure and the side wall of the electrical connection portion.

In one realizable way, the lateral indenting structure includes a step, and the step is formed due to the inner wall of the electrode pole recessing radially outwards.

In one realizable way, the lateral indenting structure includes a slope, an inner diameter of the central hole at the position corresponding to the slope gradually increases from the side near the current collecting plate to the side away from the current collecting plate. The slope and the step can be set simultaneously or separately.

In one realizable way, the side wall of the electrical connection portion and the inner wall of the central hole are fixed by laser welding, and the lateral indenting space is configured to increase a laser incidence angle.

In one realizable way, the laser incidence angle is a, and 0°<a<180°.

In one realizable way, the electrode pole is a positive electrode pole or a negative electrode pole.

Another embodiment of the present application further provides a battery, which includes the battery assembly described above.

Another embodiment of the present application further provides an electric vehicle, which includes the battery described above.

### Beneficial Effects

In the battery assembly provided by the present application, the internal resistance of the current collecting plate is greatly reduced by setting the current collecting plate as a structure in which the plate body is connected with the electrical connection portion. At the same time, by setting a central hole in the electrode pole, inserting the electrical connection portion into the central hole, and fixing the side wall of the electrical connection portion with the inner wall of the central hole through welding, the contact area between the current collecting plate and the electrode pole is increased, thereby improving the electrical conductivity of the battery, reducing the heat production of the current collecting plate, and the heat generated in the battery cell can be quickly exported through the electrode pole, thereby reducing the thermal runaway caused by high heat generation of the battery cell during high rate charging and discharging. Further, the electrical connector on the current collecting plate does not need to be bent in a “Z” shape, so it is not easy to crack, and it is convenient to weld and fix the electrical connector to the electrode pole. The assembly efficiency is high, and it is suitable for industrial production. In addition, in order to solve the problem that it is inconvenient to weld and fix the current collecting plate and the electrode pole, a lateral indenting structure is provided at the inner wall of the electrode pole near the welding position, to make the welding more convenient and the welding and fixing effect better.

### BRIEF DESCRIPTION OF THE DRAWINGS

FIG. 1 is a schematic cross-sectional view of a battery assembly according to a first embodiment of the present application.

FIG. 2 is a schematic cross-sectional view of the cover plate in FIG. 1.

FIG. 3 is a schematic cross-sectional view of the electrode pole in FIG. 1.

FIG. 4 is a three-dimensional structural diagram of the current collecting plate in FIG. 1.

FIG. 5 is a partially enlarged view of FIG. 1.

FIG. 6 is a partially enlarged view of a battery assembly according to a second embodiment of the present application.

FIG. 7 is a partially enlarged view of a battery assembly according to a third embodiment of the present application.

FIG. 8 is a partially enlarged view of a battery assembly according to a fourth embodiment of the present application.

### DETAILED DESCRIPTION OF PREFERRED EMBODIMENTS

Specific embodiments of the present application are further described in detail below in combination with the accompanying drawings. The following embodiments are used to illustrate the present application, but are not used to limit the scope of the present application.

The terms “first”, “second”, “third”, “fourth” and the like (if any) involved in the description and claims of the present application are used to distinguish similar objects, and are not used to describe a specific order or sequence.

The spatial terms “up”, “down”, “left”, “right”, “front”, “back”, “top”, “bottom” and the like (if any) involved in the description and claims of the present application are defined by the positions of the structures in the figures and the positions between the structures, only for the clarity and convenience of expressing the technical solution. It should be understood that the use of these spatial terms should not limit the scope of the present application.

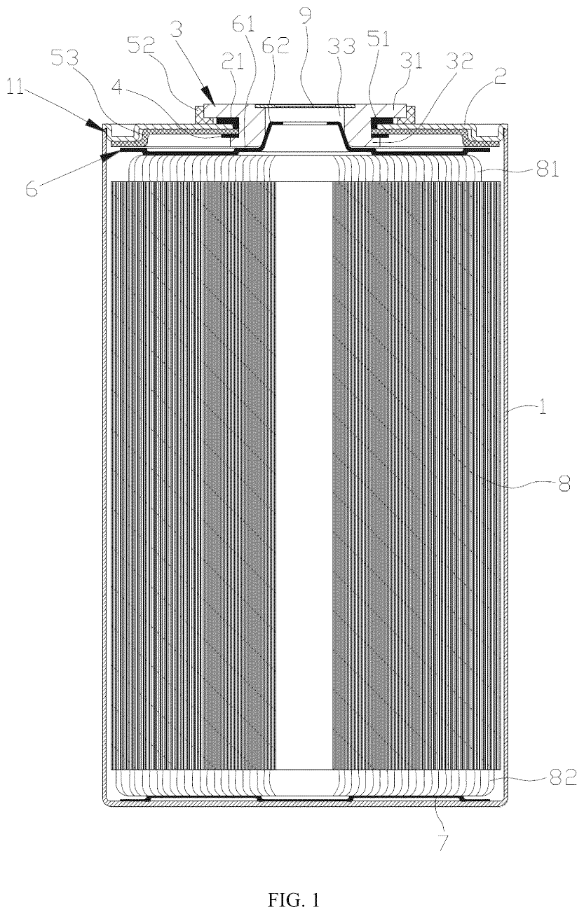

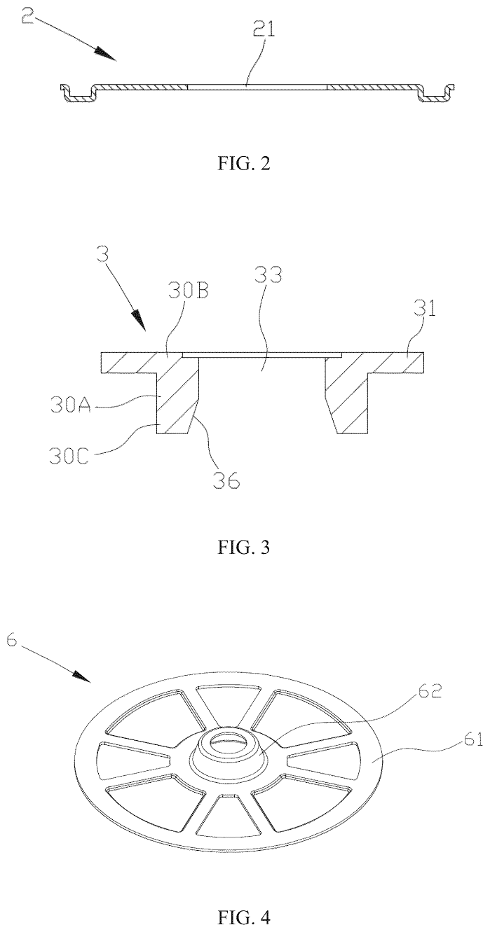

As shown in FIGS. 1 to 5, a battery assembly provided in an embodiment of the present application includes an electrode pole 3 and a current collecting plate 6. The current collecting plate 6 includes a plate body 61 and an electrical connection portion 62. The electrical connection portion 62 is formed by extending and protruding from the plate body 61 towards the electrode pole 3. The electrode pole 3 is provided with a central hole 33, the electrical connection portion 62 is inserted into the central hole 33, and the side wall of the electrical connection portion 62 and the inner wall of the central hole 33 are fixed by welding. The electrical connection portion 62 is electrically connected with the electrode pole 3, and the plate body 61 is in contact with the end face of the battery cell 8.

As shown in FIG. 1, in one embodiment, the side wall of the electrical connection portion 62 is in contact with the inner wall of the central hole 33 to realize the electrical connection between the electrical connection portion 62 and the electrode pole 3.

Specifically, in this embodiment, the internal resistance of the current collecting plate 6 is greatly reduced by setting the current collecting plate 6 as a structure in which the plate body 61 is connected with the electrical connection portion 62. At the same time, by setting a central hole 33 in the electrode pole 3, inserting the electrical connection portion 62 into the central hole 33, and fixing the side wall of the electrical connection portion 62 with the inner wall of the central hole 33 through welding, the contact area between the current collecting plate 6 and the electrode pole 3 is increased, thereby improving the electrical conductivity of the battery, reducing the heat production of the current collecting plate 6, and the heat generated in the battery cell 8 can be quickly exported through the electrode pole 3, thereby reducing the thermal runaway caused by high heat generation of the battery cell 8 during high rate charging and discharging. Further, the electrical connector on the current collecting plate 6 does not need to be bent in a “Z” shape, so it is not easy to crack, and it is convenient to weld and fix the electrical connector to the electrode pole 3. The assembly efficiency is high, and it is suitable for industrial production.

As shown in FIGS. 3 to 5, in one embodiment, the electrical connection portion 62 has a circular cross section, the electrical connection portion 62 is a hollow truncated cone shaped structure with a diameter gradually decreasing along the direction away from the plate body 61. The inner wall of the electrode pole 3 is provided with a bevel 36 matching the shape of the electrical connection portion 62, and the side wall of the electrical connection portion 62 is in contact with the bevel 36, thereby increasing the contact area between the current collecting plate 6 and the electrode pole 3.

As shown in FIG. 6, in another embodiment, the inner wall of the electrode pole 3 is provided with a lateral indenting structure near the welding position, and a lateral indenting space 300 for increasing the welding space is formed between the lateral indenting structure and the side wall of the electrical connection portion 62. The lateral indenting structure includes a step 34, and the step 34 is formed due to the inner wall of the electrode pole 3 recessing radially outwards. The side wall of the electrical connection portion 62 and the inner wall of the central hole 33 are fixed by laser welding, and the lateral indenting space 300 is used to increase the laser incidence angle. The laser incidence angle is a, and 0°<a<180°.

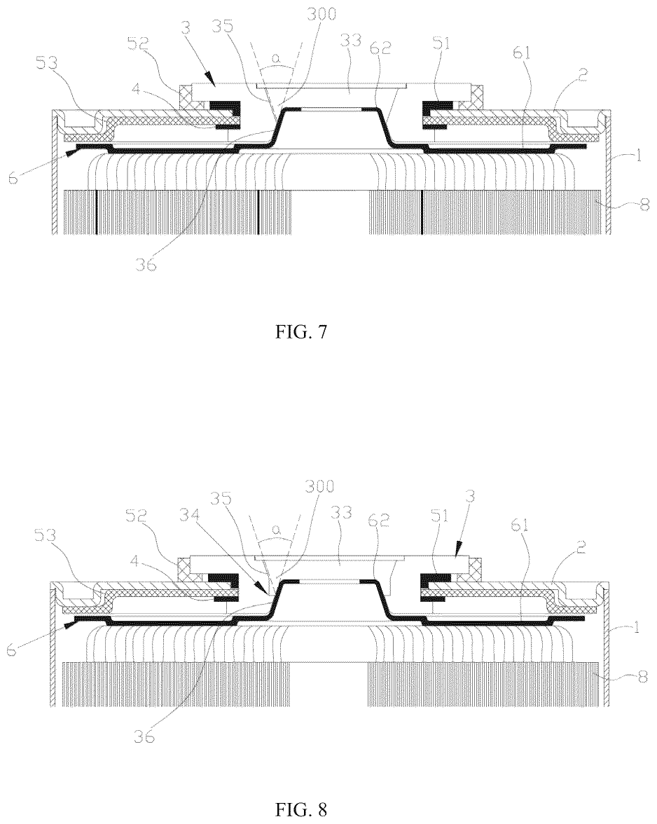

As shown in FIG. 7, in another embodiment, the lateral indenting structure includes a slope 35, and the inner diameter of the central hole 33 at the position corresponding to the slope 35 gradually increases from the side near the current collecting plate 6 to the side away from the current collecting plate 6.

As shown in FIG. 8, in another embodiment, the inner wall of the electrode pole 3 is provided with a step 34 and a slope 35 simultaneously near the welding position. However, in other embodiments, the lateral indenting structure may also be other structures, as long as the lateral indenting space 300 is formed between the lateral indenting structure and the side wall of the electrical connection portion 62.

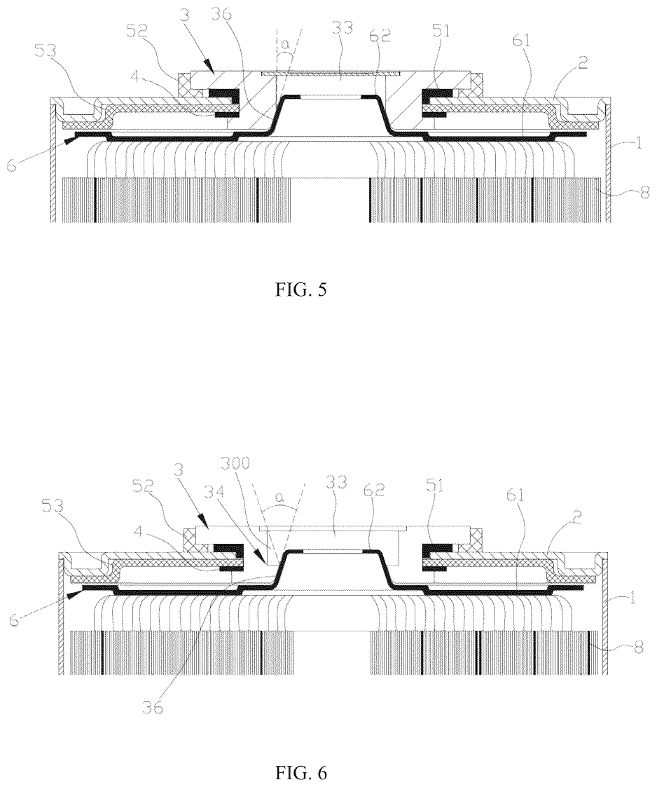

Specifically, by setting a lateral indenting structure near the welding position on the inner wall of the electrode pole 3, a lateral indenting space 300 is formed between the lateral indenting structure and the side wall of the electrical connection portion 62, which can greatly increase the laser incidence angle (a) during the welding process to ensure the best welding angle (as shown in FIG. 5, if the lateral indenting structure is not designed, the laser incidence angle (a) is greatly reduced, which is not conducive to the welding operation). In addition, when the wall thickness of the electrical connection portion 62 is relatively thin, it is easy to be burned through when it is laser welded with the inner wall of the central hole 33. In order to solve the problem of burn-through of the electrical connection portion 62 during laser welding, the laser welding position can be adjusted by setting a lateral indenting structure (step 34 or slope 35), and the welding position can be adjusted to be near or away from the electrical connection position between the current collecting plate 6 and the electrode pole 3 (i.e., the position where the side wall of the electrical connection portion 62 is in contact with the inner wall of the central hole 33) according to the actual welding effect, so as to ensure the best welding effect.

As shown in FIG. 1 and FIG. 5, in one embodiment, the battery assembly further includes a cover plate 2. The current collecting plate 6 is located on one side of the cover plate 2 near the battery cell 8. The electrode pole 3 penetrates through the cover plate 2 and is fixed with the cover plate 2 by riveting.

Specifically, in this embodiment, the electrode pole 3 and the cover plate 2 are fixed by riveting. Compared with the method of welding the electrode pole 3 and the cover plate 2, the operation is simplified, the production efficiency is improved, and the production cost is reduced.

As shown in FIGS. 1 to 3, in one embodiment, the cover plate 2 is provided with a through hole 21. The electrode pole 3 includes a main body 30A, and a first end 30B and a second end 30C respectively located at opposite ends of the main body 30A. The main body 30A is inserted in the through hole 21. The first end 30B and the second end 30C protrude from the main body 30A in opposite directions to the outside of the through hole 21. In this embodiment, the first end 30B protrudes upward from the main body 30A, and the second end 30C protrudes downward from the main body 30A. The cover plate 2, the first end 30B and the second end 30C are riveted, and the riveting part of the cover plate 2 is sandwiched between the first end 30B and the second end 30C.

As shown in FIG. 1, in one embodiment, the battery assembly further includes a pressing block 4. The pressing block 4 participates in the riveting, that is, the pressing block 4, the electrode pole 3 and the cover plate 2 are riveted. The pressing block 4 is arranged on the first end 30B and/or the second end 30C of the electrode pole 3. During the riveting, the pressing block 4 is embedded in and connected with the electrode pole 3.

Specifically, in this embodiment, the pressing block 4 may be an aluminum block. However, in other embodiments, the pressing block 4 may also be made of other materials.

As shown in FIG. 1, in one embodiment, the pressing block 4 is arranged on the second end 30C of the electrode pole 3 (that is, the pressing block 4 is used to fill the lower end of the electrode pole 3). However, in other embodiments, the pressing block 4 may also be arranged on the first end 30B of the electrode pole 3, or be arranged on both the first end 30B and the second end 30C of the electrode pole 3.

As shown in FIG. 1, in one embodiment, the pressing block 4 has an annular structure, and the pressing block 4 is sleeved on the second end 30C of the electrode pole 3. However, in other embodiments, the pressing block 4 may also be sleeved on the first end 30B of the electrode pole 3, or be sleeved on both the first end 30B and the second end 30C of the electrode pole 3.

As shown in FIG. 1, in one embodiment, the electrode pole 3 has a T-shaped structure. The first end 30B of the electrode pole 3 is provided with a stopping part 31. The stopping part 31 is formed by protruding radially outward from the side wall of the electrode pole 3, and the stopping part 31 is located on one side of the cover plate 2. The second end 30C of the electrode pole 3 is formed with a flange 32. The flange 32 is formed by protruding radially outward from the side wall of the electrode pole 3, and the flange 32 is located on the other side of the cover plate 2. In the radial direction of the electrode pole 3, the diameter of the stopping part 31 is greater than that of the flange 32. The stopping part 31, the flange 32 and the cover plate 2 are riveted, and the riveting part of the cover plate 2 is sandwiched between the stopping part 31 and the flange 32. However, in other embodiments, the second end 30C of the electrode pole 3 may be formed with the stopping part 31, and the first end 30B of the electrode pole 3 is formed with the flange 32.

Specifically, in this embodiment, the stopping part 31 is provided at the top of the electrode pole 3, the stopping part 31 is located above the cover plate 2, and the stopping part 31 is located outside the housing 1. The flange 32 is provided at the bottom of the electrode pole 3, the flange 32 is located below the cover plate 2, and the flange 32 is located inside the housing 1.

As shown in FIG. 1, in one embodiment, the pressing block 4 is sleeved on the electrode pole 3 near the flange 32, and the pressing block 4 is sandwiched between the flange 32 and the cover plate 2. During the riveting, the pressing block 4 is embedded in and connected with the flange 32. However, in other embodiments, the pressing block 4 may also be sleeved on the electrode pole 3 near the stopping part 31, in which case the pressing block 4 is sandwiched between the stopping part 31 and the cover plate 2.

Specifically, as shown in FIGS. 1 and 3, the stopping part 31 is a part of the electrode pole 3 itself (that is, the stopping part 31 exists before the electrode pole 3 and the cover plate 2 are riveted), while the flange 32 is formed during the process when the electrode pole 3 and the cover plate 2 are riveted (that is, the flange 32 does not exist before the electrode pole 3 and the cover plate 2 are riveted). Specifically, as shown in FIG. 1, in this embodiment, when the electrode pole 3 and the cover plate 2 are riveted, the electrode pole 3 of the T-shaped structure is first inserted into the through hole 21 of the cover plate 2 from top to bottom, and then the lower end of the electrode pole 3 is mechanically pressed (e.g., by rotary riveting), so as to flatten the lower end of the electrode pole 3 to form the flange 32. In the process of pressing and flattening the lower end of the electrode pole 3 to form the flange 32, an upsetting effect will be formed on the electrode pole 3 (that is, the length of the electrode pole 3 is shortened and the diameter of the electrode pole 3 is increased), and the electrode pole 3 and the cover plate 2 are fixed, so as to realize the riveting of the electrode pole 3 and the cover plate 2. Each of the stopping part 31 and the flange 32 has a limiting function, and the stopping part 31 and the flange 32 cooperate with each other to firmly clamp the cover plate 2 to prevent the electrode pole 3 from falling off from the through hole 21 of the cover plate 2. At the same time, when the electrode pole 3 and the cover plate 2 are riveted, the insulating sealing ring 51 is compressed during the formation of the flange 32, so that the gap between the stopping part 31 and the cover plate 2 is fully filled by the insulating sealing ring 51, so as to improve the sealing performance of the battery.

As shown in FIG. 1, in one embodiment, the battery assembly further includes an insulating sealing ring 51. The insulating sealing ring 51 is sleeved on the electrode pole 3 and located near the stopping part 31, and the insulating sealing ring 51 is used for insulation and sealing between the electrode pole 3 and the cover plate 2.

As shown in FIG. 1, in one embodiment, the insulating sealing ring 51 is at least partially arranged in the through hole 21, and the insulating sealing ring 51 is located between the outer wall of the electrode pole 3 and the inner wall of the through hole 21.

Specifically, in this embodiment, the insulating sealing ring 51 has a T-shaped structure (however, in other embodiments, the insulating sealing ring 51 may also be an O-shaped structure). A portion of the insulating sealing ring 51 is located in the through hole 21 (i.e., between the outer wall of the electrode pole 3 and the inner wall of the through hole 21), and another portion of the insulating sealing ring 51 is located on the outer side of the cover plate 2 and sandwiched between the stopping part 31 and the cover plate 2, so that the insulating sealing ring 51 can have a good sealing effect on the sealing between the electrode pole 3 and the cover plate 2, and can insulate the electrode pole 3 from the cover plate 2 to prevent the electrode pole 3 from electrically conducting with the cover plate 2. At the same time, when the electrode pole 3 and the cover plate 2 are riveted, during the process of pressing and upsetting the electrode pole 3, the stopping part 31 will compress the insulating sealing ring 51, so that the insulating sealing ring 51 is firmly clamped between the stopping part 31 and the cover plate 2, so as to further improve the sealing effect.

As shown in FIG. 1, in one embodiment, the battery assembly further includes an insulating ring 52. The insulating ring 52 is provided between the stopping part 31 and the cover plate 2, and the insulating ring 52 is used to insulate the electrode pole 3 from the cover plate 2, so as to prevent the electrode pole 3 from electrically conducting with the cover plate 2.

Specifically, in this embodiment, the insulating sealing ring 51 is a small ring structure with a central opening while the insulating ring 52 is a large ring structure with a central opening, and the insulating ring 52 is arranged around the outer periphery of the insulating sealing ring 51.

As shown in FIG. 1, in one embodiment, the battery assembly further includes an insulating gasket 53. The insulating gasket 53 is arranged between the pressing block 4 and the cover plate 2.

Specifically, in this embodiment, a portion of the insulating gasket 53 is located between the pressing block 4 and the cover plate 2, and another portion of the insulating gasket 53 is located between the current collecting plate 6 and the cover plate 2, so as to prevent the pressing block 4 from electrically conducting with the cover plate 2 and also prevent the current collecting plate 6 from electrically conducting with the cover plate 2.

As shown in FIG. 1, in one embodiment, the battery assembly further includes a sealing sheet 9. The sealing sheet 9 may be an explosion-proof sheet. The sealing sheet 9 is hermetically connected with the top surface of the electrode pole 3, and the sealing sheet 9 seals the central hole 33 of the electrode pole 3.

As shown in FIG. 1, an embodiment of the present application further provides a battery, which may particularly be a cylindrical battery. The battery includes the battery assembly as described above and a housing 1. The housing 1 has a cylindrical tank structure. The top of the housing 1 is provided with an opening 11. The cover plate 2 is used to seal the opening 11 of the housing 1, the cover plate 2 is fixed at the opening 11 of the housing 1, and the cover plate 2 is electrically connected with the housing 1. Two opposite ends of the electrode pole 3 are respectively located outside the opening 11 of the housing 1 and inside the opening 11 of the housing 1.

In another embodiment, the top of the cylindrical battery body is provided with a groove (not shown), and the electrode pole 3 is inserted in the groove. In addition, the groove can further be sleeved with an insulating sealing ring with an appropriate size.

As shown in FIG. 1, in one embodiment, the battery further includes a current collecting member 7 and a battery cell 8. The current collecting plate 6, the current collecting member 7 and the battery cell 8 are all arranged in the housing 1. The current collecting plate 6 is located between the electrode pole 3 and the top end of the battery cell 8, and two sides of the current collecting plate 6 are electrically connected with the electrode pole 3 and the top end of the battery cell 8, respectively. The current collecting member 7 is located between the housing 1 and the bottom end of the battery cell 8, and two sides of the current collecting member 7 are electrically connected with the housing 1 and the bottom end of the battery cell 8, respectively.

As shown in FIG. 1, in one embodiment, the two sides of the current collecting plate 6 are respectively in contact with the electrode pole 3 and the top end of the battery cell 8 to realize the electrical connection, and the two sides of the current collecting member 7 are respectively in contact with the housing 1 and the bottom end of the battery cell 8 to realize the electrical connection.

As shown in FIG. 1, in one embodiment, the current collecting member 7 is a flat and disc-shaped structure.

As shown in FIG. 1, in one embodiment, two ends of the battery cell 8 are respectively provided with a positive tab 81 and a negative tab 82. The electrode pole 3 is a positive electrode pole, the current collecting plate 6 is a positive current collecting plate, and the current collecting member 7 is a negative current collecting plate, so that two sides of the current collecting plate 6 are respectively in contact with the positive tab 81 of the battery cell 8 and the electrode pole 3, and two sides of the current collecting member 7 are respectively in contact with the negative tab 82 of the battery cell 8 and the bottom wall of the housing 1. However, in other embodiments, the electrode pole 3 may be a negative electrode pole, the current collecting plate 6 is a negative current collecting plate, and the current collecting member 7 is a positive current collecting plate, so that two sides of the current collecting plate 6 are respectively in contact with the negative tab 82 of the battery cell 8 and the electrode pole 3, and two sides of the current collecting member 7 are respectively in contact with the positive tab 81 of the battery cell 8 and the bottom wall of the housing 1.

Specifically, when the electrode pole 3 is a positive electrode pole, the housing 1 can be a steel housing (however, it can also be other materials), and in this case, the electrode pole 3 is used as the positive electrical connection terminal of the battery, and the housing 1 and the cover plate 2 are used as the negative electrical connection terminal of the battery. When the electrode pole 3 is a negative electrode pole, the housing 1 can be an aluminum housing, and in this case, the electrode pole 3 is used as the negative electrical connection terminal of the battery, and the housing 1 and the cover plate 2 are used as the positive electrical connection terminal of the battery. In this embodiment, the electrode pole 3 and the cover plate 2 are respectively used as the positive electrical connection terminal and the negative electrical connection terminal (or the electrode pole 3 is used as the negative electrical connection terminal and the cover plate 2 is used as the positive electrical connection terminal), so as to lead the positive and negative electrodes of the battery to the same side of the battery. Compared with the design that the positive electrical connection terminal and the negative electrical connection terminal are respectively arranged at opposite ends of the battery, it is conducive to the grouping of the battery and can facilitate the arrangement of the battery, reduce the number of structural parts when the battery is grouped, simplify the wiring design of BMS (battery management system), reduce the cost, make the arrangement of the battery more compact and improve the energy density of the battery.

As shown in FIG. 1, in one embodiment, the positive tab 81 and the negative tab 82 of the battery cell 8 adopt the design of full tabs. The current collecting plate 6 and the positive tab 81, or the current collecting member 7 and the negative tab 82 can be fixed by welding.

In one embodiment, an electrolyte solution is further provided in the housing 1 to charge or discharge the battery through positive and negative sheets of the battery cell 8 and the electrochemical reaction of the electrolyte solution. The electrolyte solution can be formed from organic solvents such as EC, PC, DEC, EMC and EMC and lithium salts such as LiPF₆ or LiBF₄. The electrolyte can be liquid, solid or gel state.

In the battery assembly provided by the embodiment of the present application, the internal resistance of the current collecting plate 6 is greatly reduced by setting the current collecting plate 6 as a structure in which the plate body 61 is connected with the electrical connection portion 62. At the same time, by setting a central hole 33 in the electrode pole 3 and inserting the electrical connection portion 62 into the central hole 33, the contact area between the current collecting plate 6 and the electrode pole 3 is increased, thereby improving the electrical conductivity of the battery, reducing the heat production of the current collecting plate 6, and the heat generated in the battery cell 8 can be quickly exported through the electrode pole 3, thereby reducing the thermal runaway caused by high heat generation of the battery cell 8 during high rate charging and discharging. Further, the electrical connector on the current collecting plate 6 does not need to be bent in a “Z” shape, so it is not easy to crack, and it is convenient to weld and fix the electrical connector to the electrode pole 3. The assembly efficiency is high, and it is suitable for industrial production.

The above is only the specific embodiments of the present application, but the protection scope of the present application is not limited to this. Any changes or replacements that can be easily conceived by those skilled in the technical field within the technical scope disclosed by the present application shall be covered by the protection scope of the present application. Therefore, the protection scope of the present application shall be defined by the appended claims.

1. A battery assembly comprising an electrode pole and a current collecting plate, wherein the current collecting plate comprises a plate body and an electrical connection portion, the electrical connection portion is formed by extending and protruding from the plate body towards the electrode pole, the electrode pole is provided with a central hole, the electrical connection portion is inserted into the central hole, and a side wall of the electrical connection portion and an inner wall of the central hole are fixed by welding, the electrical connection portion is electrically connected with the electrode pole.

2. The battery assembly according to claim 1, wherein the side wall of the electrical connection portion is in contact with the inner wall of the central hole to realize the electrical connection between the electrical connection portion and the electrode pole.

3. The battery assembly according to claim 2, wherein the electrical connection portion is a truncated cone shaped structure, with a diameter gradually decreasing along the direction away from the plate body, the inner wall of the central hole of the electrode pole is provided with a bevel matching the shape of the electrical connection portion, and the side wall of the electrical connection portion is in contact with the bevel.

4. The battery assembly according to claim 1, wherein the inner wall of the central hole of the electrode pole is provided with a lateral indenting structure near welding position, and a lateral indenting space for increasing the welding space is formed between the lateral indenting structure and the side wall of the electrical connection portion.

5. The battery assembly according to claim 4, wherein the lateral indenting structure comprises a step, and the step is formed due to the inner wall of the central hole of the electrode pole recessing radially outwards.

6. The battery assembly according to claim 4, wherein the lateral indenting structure comprises a slope, an inner diameter of the central hole at a position corresponding to the slope gradually increases from the side near the current collecting plate to the side away from the current collecting plate.

7. The battery assembly according to claim 4, wherein the side wall of the electrical connection portion and the inner wall of the central hole are fixed by laser welding, and the lateral indenting space is configured to increase a laser incidence angle.

8. The battery assembly according to claim 7, wherein the laser incidence angle is a, and 0°<a<180°.

9. The battery assembly according to claim 1, wherein the electrode pole is a positive electrode pole or a negative electrode pole.

10. A battery comprising the battery assembly according to claim 1.

11. An electric vehicle comprising the battery according to claim 10.

12. The battery assembly according to claim 1, wherein the battery assembly further comprises a cover plate, the electrode pole penetrates through the cover plate and is fixed with the cover plate by riveting.

13. The battery assembly according to claim 12, wherein the cover plate is provided with a through hole, the electrode pole comprises a main body and a first end and a second end respectively located at opposite ends of the main body, the main body is inserted in the through hole, the first end and the second end protrude from the main body in opposite directions to the outside of the through hole; the cover plate, the first end and the second end are riveted, and the riveting part of the cover plate is sandwiched between the first end and the second end.

14. The battery assembly according to claim 13, wherein the first end of the electrode pole is provided with a stopping part, the second end of the electrode pole is formed with a flange; the stopping part, the flange and the cover plate are riveted, and the riveting part of the cover plate is sandwiched between the stopping part and the flange.

15. The battery assembly according to claim 14, wherein the battery assembly further comprises a pressing block, the pressing block has an annular structure, and the pressing block is sleeved on the first end and sandwiched between the flange and the cover plate.

16. The battery assembly according to claim 15, wherein the battery assembly further includes an insulating gasket, and the insulating gasket is arranged between the pressing block and the cover plate.

17. The battery assembly according to claim 14, wherein the battery assembly further comprises an insulating sealing ring, the insulating sealing ring is sleeved on the electrode pole and located near the stopping part, the insulating sealing ring is arranged between the stopping part and the cover plate.

18. The battery assembly according to claim 17, wherein the insulating sealing ring has a T-shaped structure, a portion of the insulating sealing ring is located in the through hole and sandwiched between an outer wall of the electrode pole and an inner wall of the through hole, another portion of the insulating sealing ring is located on an outer side of the cover plate and sandwiched between the stopping part and the cover plate.

19. The battery according to claim 10, wherein the battery further comprises a housing, at least one end of the housing is provided with an opening, the cover plate is used to seal the opening of the housing, two opposite ends of the electrode pole are respectively located outside the opening of the housing and inside the opening of the housing.

20. The battery according to claim 19, wherein the battery further comprises a current collecting member and a battery cell, the current collecting plate, the current collecting member and the battery cell are arranged in the housing, two sides of the current collecting plate are electrically connected with the electrode pole and a top end of the battery cell respectively, and two sides of the current collecting member are electrically connected with the housing and a bottom end of the battery cell respectively.
